(19) United States
(12) Patent Application Publication
(10) Pub. No.: US 2002/0115224 A1
(43) Pub. Date: Aug. 22, 2002

(54) Method for the preparation of optical (bio)chemical sensor devices

(76) Inventors: Ulrich Rudel, Copenhagen (DK); Andreas Friccius Stange, Copenhagen (DK); Carsten Thirstrup, Charlottenlund (DK)

Correspondence Address: BIRCH STEWART KOLASCH & BIRCH, PO BOX 747, FALLS CHURCH, VA, 22040-0747, US

(21) Appl. No.: 10/075,314

(22) Filed: Feb. 15, 2002

Related U.S. Application Data
(60) Provisional application No. 60/268,933, filed on Feb. 16, 2001.

(30) Foreign Application Priority Data
Feb. 16, 2001 (DK) PA 2001 00263

(51) Int. Cl. G01N 21/75

(52) U.S. Cl. 436/164; 422/82.05; 427/2.13

(57) ABSTRACT

The present invention relates to a method for the preparation of a miniaturized optical chemical or biochemical sensor device (e.g. bulk optode, etc. for ion sensing), said device comprising a substrate material having a planar surface portion, said planar surface representing a transducer based on an optical phenomenon such as surface plasmon resonance based on evanescent waves, reflection or transmission; said planar surface portion having arranged thereon an multi-analyte array of (bio)chemical sensor dots located at spatially separated predetermined positions of the planar surface, said sensor dots including (i) a polymer matrix, and (ii) one or more (bio)chemical recognition moieties, the method comprising (a) providing a substrate material having a planar surface portion; (b) providing one or more spotting fluid(s); (c) depositing the one or more spotting fluid(s) onto the planar surface portion of the substrate material by means of a pin-printer deposition mechanism (arrayer) and allowing the spotting fluid(s) to consolidate.

### FIELD OF INVENTION

The present invention relates to the preparation of optical (bio)chemical sensor devices useful for monitoring a large number of different compounds at the same time. Other possible applications are high throughput screening of combinatorial libraries, food quality monitoring, process control, gene expression monitoring, and detection of biological components, etc. More particularly, the present invention relates to a method for the preparation of an optical (bio)chemical sensor device comprising a plurality of polymeric (bio)chemical sensor dots.

### BACKGROUND OF THE INVENTION

The trend within the field of chemical and biochemical sensors [R. Kellner, M. Otto, M. Widmer, Analytical Chemistry: The Approved Text to the FECS Curriculum Analytical Chemistry, Wiley-VCH 1998, p 359-360 and 375ff.] is to improve and develop new ways of performing classical analytical methods in order to meet the increasing demand of high throughput analysis of e.g. environmental and clinical samples as well as screening of new compounds for drug development. Especially, miniaturization of chemical and biochemical sensing techniques has received a lot of interest, a process which has been further supported by the development of new approaches for chemometric data processing and neural networks allowing access to information embedded in response patterns beyond the sum of individual results.

Chemical and biochemical sensors [i.e. (bio)chemical sensors] have been defined as “devices capable of continuously recognizing concentrations of chemical constituents in liquids or gases and converting this information in real-time to an electrical or optical signal” [R. Kellner, M. Otto, M. Widmer, Analytical Chemistry: The Approved Text to the FECS Curriculum Analytical Chemistry, Wiley-VCH 1998]. In this connection, a chemically sensitive layer is coupled to a so-called transducer, which converts the (bio)chemical information into an optical or electrical signal which is recorded by a data evaluation unit. The chemically sensitive layer can either be a surface directly modified with a recognition system or a surface covered by a thin film doped with the recognition system; e.g. chemically sensitive polymer membranes may be coupled to an electrode to measure their potential difference to a sample solution as function of analyte concentration (or activity); or they may be coated onto an optical transducer such as an optical fiber to measure an optical change (such as absorbance or refraction) as the function of analyte concentration.

Bulk optode membranes, as described in EP 0 358 991, are examples of chemical sensing layers for optical ion-sensing. Chemical substances that selectively interact with specific ions are called ionophores and have traditionally been used in potentiometric membrane electrodes to increase or govern their selectivity. Combination of the ionophore with further components, in particular, lipophilic ions (“counter ions”) and pH-sensitive dyes (“chromoionophores”), afford a membrane material that responds to specific ions, at a given pH, with a reversible and reproducible color change. Unlike their electrochemical cousins, where a reference electrode is prerequisite for measurement, optical sensors based on such membranes (“opt(r)odes”) function without a reference and are not sensitive to electrical interference, which make them much easier to integrate in miniaturized systems. Furthermore, optical methods may be combined with chemometric techniques, pattern recognition, etc., since more than one parameter can be deduced from them: e.g., spectral shape, temporal information or data on both absorbance and refraction, could be measured where electrochemical sensors commonly only yield one value (such as potential or current).

In order to combine optical sensing using chemically responsive polymers with the concept of sensing arrays, individual, small polymer dots need to be arranged on the substrate in such a manner that the signal from each individual sensing element can be distinguished from one another. One approach is to bundle or array optical fibers as demonstrated by Dickinson et al. [Nature 1996, 382, 697-700; cf. also Johnson et al., Anal. Chem. 1997, 69, 4641-4648]. Representative of the lengths gone to demonstrate the advantages of multi-sensing employing optical changes of polymer probes are the studies from the group of Walt (e.g., Anal. Chem 70 1998 1242-1248). Here, microsphere sensors are randomly entrapped in thousands of micrometer-scale wells. These are etched out of the face of an optical fiber by hydrofluoric acid, taking advantage of the different etch rates of fiber cores and cladding. Alternatively sophisticated site-selective photopolymerisation have been employed on such fiber bundle phases by the same group (see review by Steemers and Walt, Mikrochim. Acta 131, 99-105 (1999). Such studies strongly confirm the potential of miniaturized, polymer array based sensing techniques. However, individual modification and subsequent bundling of the fibers clearly makes this approach impractical for mass-production of sensor layers or production of sensor layers with many different sensor systems. On the other hand, for many practicable devices it will not be necessary to scale down the individual sensor elements to the sizes (a few micrometers) achieved in such studies. For example, 36 dots of 120 μm diameter could still easily be arranged on a 1 cm×1 cm sensor area with a 30 μm dot-to-dot distance.

An ideal sensor device should comprise a plurality of different, independently and spatially separated polymeric sensor regions (these regions, which in this context are referred to as sensing dots, have a roughly circular shape and microscopic dimensions (diameter 10-1000 μm)). An imaging technique, e.g. camera, or linear or two-dimensional CCD array, and suitable software may then be used to distinguish between the responses of the different sensing dots. These sensor devices may also show to be more flexible, reproducible, and it may be easier to increase the number of sensing regions. The potential of arrays of optical sensing regions for analysis via imaging has recently been demonstrated by Rakow et al. in a colorimetric sensor array for odour detection [Rakow et al., Nature 406 (2000) 710-713].

There are a number of different optical sensing schemes that in principle allow imaging and thus can be used with arrays of polymer-based sensing dots. In the simplest case, a transparent carrier plate could be modified with sensing dots. With a suitable gasket and cover plate, a flow channel could be created which allows flowing, e.g., a ground water sample over the dots. A light source may be mounted on top of the cover plate and shining through both plates and sample, an imaging detector (e.g., camera) below the lower plate may then record an image which contains all the information on the color response of the individual dots. Of course, it would also be possible to devise similar systems utilizing diffuse or total reflection of sensing dots on suitable non-transparent surfaces. Fluorescence monitoring would be possible in analogous systems.

More sophisticated optical sensing schemes are those using the phenomenon of evanescent waves, decaying standing waves that occur at surfaces between two phases of different refractive indices upon total reflection of light within the optically dense medium. Such waves occur either directly at the totally-reflecting surfaces, at suitable structures such as gratings, or via excitation of so-called surface plasmons (collective electron oscillations) within a thin film of suitable metals (typically gold or silver) on related suitable optical structures. Since such devices allow measurement of optical properties in the very proximity of the transducer surface, they can also be combined with arrays of polymer sensing dots as described in WO 00/46589 (Vir A/S). Furthermore, evanescent waves may be used to excite fluorescence rather than to monitor absorption thereby allowing fluorimetric sensing.

Suitable optical transducers are optical waveguides, surface plasmon resonance films, reflection grating couplers, optical waveguides, Mach-Zehnder interferometers or Hartmann interferometers, allowing detection of changes of optical properties of the polymer dots, such as in particular absorption, refractive index or fluorescent changes (thus allowing to monitor the chemical response of the polymer dots).

However, so for there is no automated way of producing arrays of spatially separated (bio)chemical sensor dots for optical sensing.

Several techniques for automated dispersion of fluid droplets are available. The ink-jet technology which is known from e.g. printing technology is characteristic by that the fluid is deposited from a capillary. Release of the fluid from the capillary can be brought about by different approaches. In the drop-on-demand approach application of a voltage through a piezo-actuator, a ceramic collar around the capillary, creates an acoustic wave in the capillary and the resulting deformation of the capillary causes release of a controlled part of the liquid column as droplets. In the continuous approach, the fluid is released under pressure resulting in the generation of a fluid stream and again droplets are generated and released from the capillary by the application of a voltage through a piezo-electric actuator. The continuous ink-jet technique is widely used for labeling of products in the food and pharmaceutical industry. The ink-jet technology has also been used by Newmann et al. [Newman et al. Analytical Chemistry 1995, 67, 4594-4599] in the preparation of membranes for amperometric biosensors, where, however, the droplets merge to form a film. Other related techniques are micro- and nanodispensing instruments, such as micropipettes.

None of these techniques are suitable for deposition of fluids with low surface tension and high viscosity as application of these solvents offend result in formation of air bubbles in the dispensing devices. Heating of the print-head may reduce the viscosity of the fluid but it may also cause evaporation of volatile solvent and clogging of the print-head may be experienced. It is further known that viscolelasticity causes significant performance problems in such printers. Non-Newtonian behavior may occur under the high shear forces in the nozzles resulting in unstable drop formation or formation of droplet satellites.

It is clear from the above brief overview that the ink-jet technology is not a suitable choice for deposition of polymer or polymer precursor fluids. The physicochemical properties of these fluids will interfere with the deposition process as well as the aspiration through a pump into the dispensing mechanism.

Alternative technologies for microarraying of fluids which do not involve sample aspiration, pumping and flushing are open deposit units such as pin-printers or arrayers, e.g. the quill-printer as described in U.S. Pat. No. 5,807,522. In the pin-printer technology the fluid to be deposited is picked up from a small vessel (usually the well of a microtiter plate). Thus, the amount of spotting fluid needed to fill the instrument is minimized which is an important feature in the preparation of sensing membranes given the high prize of (bio)chemical recognition elements. Quill-printers, however, are not suitable for the deposition of polymer and polymer precursor fluids with high viscosity as the reception of fluid is based on take-up of fluid into the quill and problems as described above may arise. Another disadvantages is the fact that it is very hard to reproduce the size of the deposited fluid dots, e.g. some commercially available printers need pre-printing steps to achieve a constant dot size.

Another example of an open deposit unit is the pin-ring technology as described in WO 99/36760. The pin-ring technology is developed for the preparation of reproducible microarrays of biological samples and is based on surface tension forces as the basic mechanism for holding and transferring the fluid.

### SUMARY OF THE INVENTION

The present invention relates to a method for the preparation of an optical (bio)chemical sensor device as defined in claim 1.

The present invention also relates to such optical (bio)chemical sensor devices obtainable by said method, and to methods of using the devices.

### BRIEF DESCRIPTION OF THE FIGURES

FIG. 1: Photographic image of a plurality of sensor dots obtained by “pin-ring” deposition of a spotting fluid comprising PVC/DOS in cyclohexanone (Example 2). The dot diameter is approximately 200 μm.

FIG. 2: Fluorescence image of arrays (A-D) of photopolymerized methacrylate spotting fluid droplets obtained by deposition of a spotting fluid comprising methacrylate (Example 4) and subsequent polymerization of the polymer precursors on the support surface. A second set of arrays was superimposed directly on top of A, C and photopolymerized (Example 5.I).

FIG. 3: Partially superimposed PVC-DOS dot arrays generated by means of a “pin-ring” calibration feature (Example 5.II) (image obtained with fluorescence scanner). The outer white box encircles the second array, the inner one the area of dot superimposition.

### DETAILED DESCRIPTION OF THE INVENTION

The present invention relates to a method for the preparation of an optical (bio)chemical sensor device. The (bio)chemical sensor device includes a plurality of well-defined spatially separated (bio)chemical sensor dots arranged on a substrate material. More specifically, the optical (bio)chemical sensor device comprises a substrate material having a planar surface portion, said planar surface representing a transducer based on an optical phenomenon, said planar surface portion having arranged thereon a plurality of (bio)chemical sensor dots located at spatially separated predetermined positions of the planar surface, said sensor dots comprises (i) a polymer matrix, and (ii) one or more (bio)chemical recognition moieties.

The term “plurality” in connection with the expression “plurality of (bio)chemical sensor dots” is synonymous with the term “array” which is frequently used in the technical literature.

The term “(bio)chemical” is intended to have the same meaning as “biochemical and chemical”, thereby covering reactions and reagents within the biochemical as well as the chemical field.

The term “recognition moieties” is intended to cover chemical groups which interacts with an analyte in order to directly, or indirectly, alter the optical properties of the associated polymer matrix, as well as chemical groups which, e.g. in a cascade fashion, are involved in the alteration of the optical properties. The term “recognition system” covers a system comprising one or more recognition moieties which all in all (e.g. by a cascade reaction) is responsible for alteration of the optical properties of the associated polymer matrix.

The sensor device comprises a “substrate material” having a planar surface portion. The term “substrate material” is intended to mean a base material optionally coated with one or more layers of a surface layer material (see below). It should be understood that the planar surface portion of the substrate material should represent a transducer based on an optical phenomenon.

The dimension of the planar surface portion of the substrate material is typically 1-50 mm wide and 2-100 mm long, such as 2-25 mm wide and 5-50 mm long, e.g. 4-8 mm wide and 8-16 mm long.

The substrate material comprises a base material and optionally a surface layer material which represent the planar surface portion of the substrate material. In some embodiments, it is possible to utilize a substrate material wherein the base material and the surface layer material is the same material. The substrate may of course also comprise multiple layers of the surface layer material.

An important requirement for the method to be applicable for the preparation of a plurality of (bio)chemical sensor dots is that the deposited fluids remain localized to the predetermined positions and do not spread to wet the entire substrate material. The contact area of a sensor dot defines the size (diameter) of the dot.

The base material constitute an integrated part of the (bio)chemical sensor device, and is typically in the form of a smooth planar surface of a material selected from glass, silica, dielectric inorganic materials such as SiO₂, PtOₓ where x=1 or 2, Al₂O₃, TiO₂, Ta₂O₅, MgF₂, or Si₃N₄, plastics such as acrylics, cycloolefin polymer (TOPAS™), polycarbonate, polyetherimide (ULTEM™), or silicon with a hydrogen- or deuterium-terminated surface, in particular glass and plastics.

In the present context, the term “dielectric” means a material that is a poor conductor of electricity and that will sustain the force of an electric field passing through it.

The base material is often coated with at least one layer of a surface layer material so as to govern optical performance of the transducer. Such surface layer materials are typically selected from metal (such as gold, silver, copper or platinum), silica and silicon, preferably from gold, silver, copper and silicon.

The surface layer material typically has a thickness of 10-500 nm, such as 20-80 nm which is particularly relevant for surface plasmon resonance measurements.

In one embodiment of the invention the substrate material is a multilayered structure of one or more metals and a dielectric inorganic material as defined above, the multilayred structure may e.g. be a metal-dielectric or a metal-dielectric-metal sandwich structure.

In one embodiment of the invention the substrate material is transparent allowing measurement of the bulk absorption of the (bio)chemical sensor dots.

In another embodiment of the invention the support surface is totally-reflecting allowing reflectance-spectroscopic measurement of the optical properties of the (bio)chemical sensor dots.

In yet another embodiment of the invention the support surface is diffusely-reflecting to allow diffuse-reflectance spectroscopic measurement of the optical properties of the (bio)chemical sensor dots.

The size, shape and adherence of the (bio)chemical sensor dots may be further controlled by modification of the surface of the substrate material thereby reducing or increasing the capacity of the spotting fluid to wet the surface or become chemically bonded thereto.

In one embodiment of the invention the planar surface of the substrate material is chemically modified by treatment with a bifunctional reagent:

X—Z—Y

wherein

X is selected from —OR′, asymmetric or symmetric disulfides (—SSR′Y′, —SSRY), sulfides (—SR′Y′, —SRY), diselenide (—SeSeR′Y′, —SeSeRY), selenide (—SeR′Y′, —SeR′Y′), thiol (—SH), selenol (—SeH), —N≡C, —NO₂, trivalent phosphorous groups, —NCS, —OC(S)SH, thiocarbamate, phosphine, thio acid (—COSH), dithio acid (—CSSH), —Si(OR/R/H)₃, and halogen;

each of the substituents R and R′ independently are selected from optionally substituted C₁₋₃₀-alkyl, optionally substituted C₂₋₃₀-alkenyl, optionally substituted C₂₋₃₀-alkynyl, and optionally substituted aryl;

Y and Y′ are selected from hydroxyl, carboxyl, amino, formyl, hydrazine, carbonyl, epoxy, vinyl, allyl, acryl, epoxy, and methacryl,

Z is a linker (biradical) between the two functional groups and typically designates optionally substituted C₁₋₁₂-alkylene, optionally substituted C₂₋₁₂-alkenylene, and optionally substituted C₂₋₁₂-alkynylene which may be interrupted by heteroatoms such as N, S, O and Si.

In the present context, the term “C₁₋₃₀-alkyl” means a linear, cyclic or branched hydrocarbon group having 1 to 30 carbon atoms, such as methyl, ethyl, propyl, iso-propyl, cyclopropyl, butyl, tert-butyl, iso-butyl, cyclobutyl, pentyl, cyclopentyl, hexyl, cyclohexyl, hexadecyl, heptadecyl, octadecyl, nonadecyl, likewise the term “C₁₋₆-alkyl” means a linera, cyclic or branched hydrocarbon group having 1 to 6 carbon atoms, such as methyl, ethyl, propyl, iso-propyl, butyl, tert-butyl, iso-butyl, pentyl, cyclopentyl, hexyl, cyclohexyl, in particular methyl, ethyl, propyl, iso-propyl, tert-butyl, iso-butyl and cyclohexyl.

Similarly, the terms “C₂₋₃₀-alkenyl” is intended to mean a linear, cyclic or branched hydrocarbon group having 2 to 30 carbon atoms and one or more unsaturated bonds, likewise the terms “C₂₋₆-alkenyl” is intended to mean a linear, cyclic or branched hydrocarbon group having 2 to 6 carbon atoms and one or more unsaturated bonds. Examples of alkenyl groups are vinyl, allyl, butenyl, pentenyl, hexenyl, heptenyl, octenyl, heptadecaenyl. Examples of alkadienyl groups are butadienyl, pentadienyl, hexadienyl, heptadienyl, heptadecadienyl. Examples of alkatrienyl groups are hexatrienyl, heptatrienyl, octatrienyl, and heptadecatrienyl.

Similarly, the term “C₂₋₃₀-alkynyl” is intended to mean a linear or branched hydrocarbon group having 2 to 30 carbon atoms and comprising a triple bond. Examples hereof are ethynyl, propynyl, butynyl, octynyl, and dodecaynyl.

In connection with the terms “alkyl”, “alkenyl”, and “alkynyl”, the term “optionally substituted” means that the group in question may be substituted one or several times, preferably 1-3 times, with group(s) selected from hydroxyl, C₁₋₆-alkoxy, carboxyl, C₁₋₆-alkoxycarbonyl, C₁₋₆-alkylcarbonyl, formyl, aryl, aryloxycarbonyl, arylcarbonyl, heteroaryl, amino, mono- and di(C₁₋₆-alkyl)amino, carbamoyl, mono- and di(C₁₋₆-alkyl)aminocarbonyl, amino-C₁₋₆-alkyl-aminocarbonyl, mono- and di(C₁₋₆-alkyl)amino-C₁₋₆-alkyl-aminocarbonyl, C₁₋₆-alkylcarbonylamino, cyano, carbamido, halogen, where aryl and heteroaryl may be substituted 1-5 times, preferably 1-3 times, with C₁₋₄-alkyl, C₁₋₄-alkoxy, nitro, cyano, amino or halogen. Especially preferred examples are hydroxyl, C₁₋₆-alkoxy, carboxyl, aryl, heteroaryl, amino, mono- and di(C₁₋₆-alkyl)amino, and halogen, where aryl and heteroaryl may be substituted 1-3 times with C₁₋₄-alkyl, C₁₋₄-alkoxy, nitro, cyano, amino or halogen (such as fluoro, chloro, bromo, and iodo).

In the present context the term “aryl” means a fully or partially aromatic carbocyclic ring or ring system, such as phenyl, naphthyl, 1,2,3,4-tetrahydronaphthyl, anthracyl, phenanthracyl, pyrenyl, benzopyrenyl, fluorenyl and xanthenyl, among which phenyl is a preferred example.

In connection with the term “aryl”, the term optionally substituted” means that the group in question may be substituted 1-5 times, preferably 1-3 times, with C₁₋₄-alkyl, C₁₋₄-alkoxy, nitro, cyano, amino or halogen.

The term “heteroaryl” means a fully or partially aromatic carbocyclic ring or ring system where one or more of the carbon atoms have been replaced with heteroatoms, e.g. nitrogen (═N— or —NH), sulphur, and/or oxygen atoms. Examples of such heteroaryl groups are oxazolyl, isoxazolyl, thiazolyl, isothiazolyl, pyrrolyl, imidazolyl, pyrazolyl, pyridinyl, pyrazinyl, pyridazinyl, piperidinyl, coumaryl, furyl, quinolyl, benzothiazolyl, benzotriazolyl, benzodiazolyl, benzooxozolyl, phthalazinyl, phthalanyl, triazolyl, tetrazolyl, isoquinolyl, acridinyl, carbazolyl, dibenzazepinyl, indolyl, benzopyrazolyl, phenoxazonyl.

The functional group Y is often chosen to interact with a polymer or polymer precursors. In some embodiments, Y and Y′ are the same.

Chemical modification of the surface changes the capability of a spotting fluid to wet the substrate material and this material may therefore be tailored to a specific composition of a spotting fluid affording well-defined sensor dots.

In one embodiment of the invention Y represent an amino-groups which may react with polyvinylchloride affording polyvinylchloride dots covalent bound to the substrate material.

In another embodiment of the invention treatment of a gold or silver coated surface with allyl- or methacroyl thiol affords a surface which may react with polymer precursors such as methacrylate or acrylate during polymerization to afford a plurality of methacrylate- or acrylate sensor dots covalently bound to the substrate material.

In yet another embodiment of the invention treatment of a glass or silicon oxide surface with an allyl- or methacroyl silane affords a surface which may react with polymer precursors such as methacrylate or acrylate during polymerization to afford a plurality of methacrylate- or acrylate sensor dots covalently bound to the substrate material.

In yet another embodiment of the invention treatment of a gold or silver coated surface with a hydroxyl-terminated aliphatic thiol such as 11-mercaptoundecanol affords a surface which allows deposition of stable droplets of a spotting fluid containing dodecyl methacrylate and 1,6-hexanediol dimethacrylate.

In an alternative embodiment of the invention, vetting of the substrate material is controlled by microstructures such as small wells on the surface of the substrate material. The spotting fluid is deposited into the wells wherein it is allowed to spread. The diameter and the depth of the wells define the size and the height of the resulting sensor dots. In one preferred embodiment of the invention the diameter of the wells is between 50 and 1000 μm, and the depth of the wells is between 1 and 50 μm.

The substrate material has a planar surface portion. It should be understood that not all of the substrate material needs to represent a planar surface, or planar surfaces within the device. The substrate material may have other portions with gratings, rims which expand above the planar surface, holes for mounting, etc. What is important in connection with the present invention is that the substrate material has at least one planar surface portion on which the plurality (bio)chemical sensor dots are established.

This planar surface portion represents a “transducer based on an optical phenomenon”. The term “optical phenomenon” is intended to cover refraction, reflection, diffuse reflectance, attenuated reflectance, transmission, spectral changes, color changes, absorption, critical angle of reflection, evanescent wave phenomena such as surface plasmon resonance, fluorescence, and fluorescence quenching, preferably transmission, fluorescence, and surface plasmon resonance, in particular surface plasmon resonance. These phenomena form the basis for a number of transducer technologies such as spectroscopy, spectrophotometry, photometry, SPR technology, Total Internal Reflection Fluorescence (TIRF) sensing, Grating Coupler Sensing (GCS), Resonant Mirror sensing, Reflectometric Interference Spectroscopy (RIFS), Integrated Optical Devices (Waveguides), Integrated-Optical Interferometers, critical angle refractometry, etc.

The term “change in optical properties” and similar terms are intended to encompass changes of the optical phenomena mentioned above, allowing detection of changes of optical properties of the (bio)chemical sensor dots, such as in particular absorption, refractive index or fluorescent changes (thus allowing to monitor the chemical response of the polymer dots).

The individual (bio)chemical sensor dots may have the same composition, but typically the sensor dots are not all identical. Thus, the device prepared according to the invention typically comprises at least 5, such as at least 15, different sensor dots. This being said, the polymer matrix of the different sensor dots is typically identical, whereas the one or more (bio)chemical recognition moieties are different, thereby rendering it possible to identify a plurality of analytes on the same device. In a preferred embodiment each of the spatially separated (bio)chemical sensor dots comprise different (bio)chemical recognition moieties.

Alternatively, the composition of the some of the sensor dots may be identical so as to image the distribution of an analyte in an inhomogeneous sample.

The (bio)chemical sensor devices formed by the method according to the invention comprise a plurality of (bio)chemical sensor dots in spatially separated predetermined positions in the x-y plane of the planar surface portion of the substrate material. For practical purposes, it is often desirable to deposit the sensor dots with a uniform distance between the sensor dots in the x-direction and a uniform distance between the sensor dots in the y-direction, where the distance between the dots in the x- and y-direction may be the same or different. In a preferred embodiment of the invention the distances between the centers of the (bio)chemical sensor dots in the x- and y-direction independently are in the range of 1.1-10 times the diameter of the (bio)chemical sensor dots.

In order to establish a plurality of (bio)chemical sensor dots, the method comprising

(a) providing a substrate material having a planar surface portion;

(b) providing one or more spotting fluid(s) each comprising at least one of

(i) a polymer and/or polymer precursor; and

(ii) a component representing one or more (bio)chemical recognition moieties;

(c) depositing either simultaneously or sequentially the one or more spotting fluid(s) at the spatially separated predetermined positions of the planar surface portion of the substrate material by means of a “pin-ring” deposition mechanism and allowing the spotting fluid(s) to consolidate.

The term “consolidation” is intended to include polymerisation, polycondesation, crosslinking, sol-gel processing, evaporation of solvent(s), e.g. upon exposure to heat, irradiation with ultraviolet light, irradiation with visible light, or by means of electron induced excitation.

The method comprises spotting a fluid comprising one or more polymers or polymer precursors, hereinafter termed “spotting fluid”, onto the planar surface portion of a substrate material, by means of a “pin-ring” depositing technique. Subsequent consolidation of the spotting fluid droplets on the support surface, either by means of evaporation of a solvent, polymerization of polymer precursors or a combination thereof, affords a plurality of spatially separated sensor dots.

The “pin-ring” depositing technique applied in the present invention was originally introduced by Genetic MicroSystems™ (WO 99/36760) as a method for preparation of in particular microarrays of biological materials where the biological materials were either adherently or covalently bound to a two-dimensional surface. The present inventors have now found that the “pin-ring” depositing system can advantageously be used for the preparation of a plurality of (bio)chemical sensor polymer dots where the (bio)chemical recognition moieties are comprised in the three-dimensional matrix of or on the surface of spatially separated sensor dots.

The “pin-ring” depositing technique relies on surface tension forces as the basic mechanism for holding and transferring fluids. The key mechanical component consists of a circular open “ring” which is oriented parallel to the substrate, and which is held in place by a vertical rod running perpendicular to the ring. A vertical pin is centred on the ring. Both the ring rod and the pin are attached to control devices so that each part can be moved separately in the z-axis, while both are kept in constant relation to one another in the x-y plane. When the ring is dipped into a spotting fluid and lifted, it withdraws an aliquot of sample, which is held in the centre of the ring by surface tension. The pin-ring mechanism is then moved to any desired location in the x-y plane. When one desires to make a dot on the substrate material, the pin is driven down through the ring. When the pin passes through the ring, a portion of the spotting fluid is transferred from the interior ring meniscus to the bottom of the pin, forming a new pendant drop on the lower surface of the pin. The pin continues to move downward until the fluid on the pin makes contact with the substrate material. The pin is then lifted, and the combined forces of gravity and surface tension causes the spotting fluid to be deposited on the substrate material as a dot.

Neither impact nor mechanical contact between the pin and substrate are required for fluid transfer.

Movement of the pin through the internal meniscus of the ring does not destroy the meniscus until enough aliquots of fluid have been removed such that some minimal volume threshold has been passed. Given the volumes presented in the ring and on the pin, the pin driving process can be repeated many times, so that a very large number of similar dots can be created from a single moving pin-ring assembly.

The volume of the deposit fluid is dependent on pin dimensions and is roughly equal to the volume of a hemisphere with a radius equal to the radius of the pin which, with today's available hardware, is in the range of 50 to 500 μm. This is typically desirable for the embodiments described herein.

Characteristic for the present invention is that at least one of the spotting fluid(s) comprises a polymer and/or polymer precursor, and that at least one of the spotting fluids comprises a component representing one or more (bio)chemical recognition moieties.

In one embodiment, only one spotting fluid comprising the polymer and/or polymer precursor as well as the components representing one or more (bio)chemical recognition moieties is utilized.

In a preferred embodiment, at least two spotting fluids are utilized; a first spotting fluid comprising a polymer and/or polymer precursor, and a second spotting fluid comprising a component representing one or more (bio)chemical recognition moieties. In a preferred embodiment, the first spotting fluid is deposited before the second spotting fluid.

Examples of suitable polymers are plastic resins which comprise polyacrylates such as poly(methyl propenoate) or poly(2-methyl propenoate), polyanilines, poly(butadiene), polyethylene, poly(ethylene-co-vinyl acetate), polymethacrylates such as poly(methyl methacrylate), poly(octyl methacrylate), poly(decyl methacrylate) or poly(isodecyl methacrylate), polystyrenes such as polystyrene, poly(4-tert-butyl styrene) or poly(4-methoxy styrene), polypyrroles, polythiophenes, polyurethanes such as Tekoflex® EG 80 A, poly(vinyl acetate), poly(vinyl alcohol), poly(vinyl chloride), epoxy novolac resins such as SU 8 from Shell, and co- or terpolymers of the above mentioned polymers such as poly(ethylene-co-vinyl acetate). Particular examples are poly(decyl methacrylate), poly(isodecyl methacrylate), Tekoflex® EG 80 A, and poly(vinyl chloride).

In the present context the term “polymer precursor” designates monomers, dimers, oligomers, prepolymers, as well as crosslinkers which upon polymerization, polycondensation, and crosslinking to form a macromolecular, polymeric structure.

Examples of plastic monomers are monomeric acrylates such as acrylic acid, n-butyl acrylate, isodecyl acrylate, acrylamide, hexanediol diacrylate, cyclohexanediol diacrylate, N,N′ methylene bisacrylamide or tripropylene glycol diacrylate, monomeric methacrylates such as methacrylic acid, methyl methacrylate, ethyl methacrylate, n-butyl methacrylate, isobutyl methacrylate, hexyl methacrylate, nonyl methacrylate, decyl methacrylate, dodecyl methacrylate, hydroxyethyl methacrylate, glycidyl methacrylate, trifluoroethyl methacrylate, ethylene glycol dimethacrylate, triethylene glycol dimethacrylate or 1,6-hexanediol dimethacrylate. Particular examples of plastic monomers are n-butyl acrylate, isodecyl acrylate, decyl methacrylate, and 1,6-hexanediol dimethacrylate.

Another class of monomeric units comprised by the invention is metal or semimetal compounds such as organosilanes, e.g. tetramethoxysilane, 3-aminopropyltrimethoxy silanes, and tetramethylorthosilicate, which upon hydrolysis of the alkyl-O—Si bonds afford silanols (SiOH-groups) followed by polycondensation to form sol-gels (—Si—O—Si—). In this instance a sol-gel (“polymer” precursor) is utilised in combination with an alcohol a as solvent, water and an acid.

Examples of oligomers are aliphatic urethane diacrylate oligomers such as Ebecryl 230 (MW 5000) and Ebecryl 270 (MW 1500) (from UCB chemicals), and proteins such as bovine serum albumine (BSA) which in combination with a crosslinker, e.g. glutardialdehyde, form a water-insoluble macromolecular, polymeric structure which may physically entrap biochemical recognition elements.

As may be apparent, the spotting fluid may further comprise one or more solvents. The solvent or solvent mixture should be selected so that the polymers and/or polymer precursors stay dissolved or suspended therein during the depositing process and so that consolidation of the spotting fluid does not occur until the spotting fluid has been deposited as droplets onto the substrate material. Preferably, the solvent or solvent mixture evaporates spontaneously after deposition of the spotting fluid onto the substrate material. However, for some non-volatile solvents or solvents mixtures it may be necessary to apply heat or reduced pressure in order to ensure proper and rapid evaporation of the solvent or solvent mixture and following consolidation of the sensor dots.

Suitable solvents are ketones such as acetone, butanone, 4-methyl-2-pentanone, cyclopentanone or cyclohexanone, hydrocarbons such as n-hexane, n-pentane, benzene, toluene or xylene, esters such as ethyl acetate, propyl acetate, butyl acetate or diethyl sebacate, alcohols such as methanol, ethanol, glycerol, ethanolamine or phenol, acides such as formic acid, or acetic acid, amides such as N,N-dimethyl formamide, N,N-dimethyl acetamide or N-methyl pyrrolidon, halogenated hydrocarbons such as dichloromethane, chloroform, tetrachlorethane or chlorobenzene, nitromethane, nitrobenzene, water and mixtures thereof.

The spotting fluid may further comprise one or more plasticizer. Examples of suitable plasticizers are esters such as bis(1-butylpentyl) adipate, bis(1-butylpentyl)decane-1,10-diyl diglutarate, bis(2-ethylhexyl) adipate, bis(2-ethylhexyl) phtalate, bis(2-ethylhexyl) sebacate, dibutyl phtalate, dibutyl sebacate, 10-hydroxydecyl butyrate, tetraundecyl benzhydrol-3,3′,4,4′-tetracarboxylate, tetraundecyl benzophenone-3,3′,4,4′-tetracarboxylate, tris(2-ethylhexyl) trimellitate, dibutyltin dilaureate, dioctyl phenylphosphonate, isodecyl diphenyl phosphate, tributyl phosphate or tris(2-ethylhexyl) phosphate, ethers such as dibenzyl ether, benzyl 2-nitrophenyl ether, 2-cyanophenyl octyl ether, dodecyl 2-nitrophenyl ether, dodecyl [2-(trifluoromethyl)phenyl]ether, [12-(4-ethylphenyl)dodecyl]2-nitrophenyl ether, 2-fluorophenyl 2-nitrophenyl ether, 2-nitrophenyl phenyl ether, 2-nitrophenyl octyl ether, 2-nitrophenyl pentyl ether or octyl [2-trifluoromethyl)phenyl]ether, alcohols such as 1-decanol, 1-dodecanol, 1-hexadecanol, 1-octadecanol, 5-phenyl-1-pentanol or 1-tetradecanol, halogenated hydrocarbons such as 1-chloronaphtalene or chloroparaffin, phosphin oxides such as trioctylphosphine oxide, and mixtures thereof. Particular examples are bis(2-ethylhexyl) sebacate, dodecyl [2-(trifluoromethyl)phenyl]ether, and 2-nitrophenyl octyl ether.

In one embodiment of the invention the plasticizer constitutes the solvent.

A particular example of a spotting fluid according to the invention comprises poly(vinyl chloride) (PVC) and bis(2-ethylhexyl) sebacate (DOS) in the ratio of from 1:1 to 1:4 such as around 1:2, dissolved in cyclohexanone. Cyclohexanone evaporates at a suitably slow rate allowing deposition of about 100-400 fluid droplets onto the substrate material without clogging of the depositing mechanism.

When the spotting fluid comprises polymer precursors, polymerization (one type of consolidation) of the polymer precursors is required in order to obtain polymer dots. Preferably, the polymerization/consolidation process does not takes place until after deposition of the spotting fluid droplets onto the substrate material and occurs either spontaneously or initiated by exposure of spotting fluid droplets to heat, irradiation with ultraviolet or visible light, or by means of electron induced excitation. However, for some polymer precursors the polymerization process will not be initiated or will be undesirable slow unless a polymerization initiator is present. Thus, the spotting fluid may further comprise a polymerization initiator. An example of a polymerisation initiator is the radical initiator, α,α-dimethoxy-α-phenylacetophenon, which may further be combined with a photosensitizer such as benzophenone or benzoyl peroxide.

Likewise, polycondensation of polymer precursors, as in the formation of a sol-gel, may require the presence of water and/or acids which may be comprised by the spotting fluid. In some instance polycondensation may be initiated by exposure of the deposited sol-gel precursor spotting fluid to water and/or acid vapor.

The function of the polymer matrix is to provide a carrier for the (bio)chemical recognition system. In the present invention, (bio)chemical recognition system relates to a complex that may be comprised of one or more components, which upon exposure to a particular analyte induces a change in the physical property, e.g. the optical property, of the polymer matrix. The planar surface portion of the substrate material forms a suitable transducer which thereby facilitates detection of the change in the physical (optical) property of the polymer matrix, thereby, allowing the detection and quantification of a particular analyte. It should be understood that not all the (bio)chemical recognition moieties have to interact directly with the analyte, but that their combination (e.g. in a cascade fashion) bring about a change in the physical property of the polymer matrix.

The components representing the (bio)chemical recognition moieties are retained near the interface or in the matrix of the sensor dot either by physical entrapment within the polymeric network, by covalent linkage to the polymer backbone, by ionic interaction with charged groups on the polymer, or by physical dissolution in the polymeric phase.

In an alternative embodiment of the invention one or more components of the (bio)chemical recognition system are directly immobilized on the surface of a sensor dot. This is particularly interesting for biochemical recognition moieties comprising enzymes, antibodies, catalytic antibodies, proteins, nucleic acids and derivatives thereof such as PNA (protein nucleic acid), or LNA (locked nucleic acid), aptamers, receptors, or cell- and tissue segments. However, these biochemical recognition moieties may also be retained near the interface or in the matrix of the sensor dot as described above. It should however be understood that such recognition moieties attached to the surface of the polymer matrix are only considered a part of the recognition system if there is a direct chemical link to the remaining (embedded) components of the recognition system.

In a preferred embodiment of the invention the sensor device prepared by the method comprises a plurality of optode membranes. An optode membrane is considered as a single, thermodynamic homogeneous phase, which responds reversibly to the activity of an analyte. An optode membrane consists of a polymer matrix which serves as a carrier for the chemical recognition moieties. The chemical recognition system may comprise a ligand (ion carrier, ionophor, indicator, complexing agent) which is either chemically bound or physically entrapped in the polymer matrix. An optical signal is generated upon interaction of the ligand with the analyte, whereupon the ligand itself or an additional compound (chromoionophore, fluoroionophore, indicator dye) changes its optical properties upon complexation with another ion.

In one embodiment of the invention the sensor device prepared by the method is a plurality of ion-selective optode membranes, where the chemical recognition system comprises, e.g., an ion-selective, electrically neutral ionophore and an H⁺-selective electrically neutral chromoionophore as well as lipophilic anionic sites. The membrane changes its color upon exchanging a hydrogen ion against the analyte cation. This change of the spectral properties is used for optical detection. To ensure constant amount of ions present within the polymer matrix, lipophilic anionic sites are added.

Examples of ionophores are those selected from the group consisting of ion specific ionophores such as the lithium specific ionophores N,N′-diheptyl-N,N′,5,5-tetramethyl-3,7-dioxanonanediamide, or N,N,N′,N′-tetraisobutyl-cis-cyclohexane-1,2-dicarboxamide, the sodium specific ionophores N,N′,N″-trimethyl-4,4′,4″-propylidyne tris (3-oxabutyramide), 4-octadecanoyloxymethyl-N,N,N′,N′-tetracyclohexyl-1,2-phenylenedioxydiacetamide, or 4-tert-butylcalix[4]arene-tetraacetic acid tetraethyl ester, the potassium specific ionophores Valinomycin, 2-dodecyl-2-methyl-1,3-propanediyl bis[N-[5′-nitro(benzo-15-crown-5)-4′-yl]carbamate], or 4-tert-butyl-2,2.14,14-tetrahomo-2a,14a-dioxacalix[4]arene-tetraacetic acid tetra-tert-butyl ester, the ammonium specific ionophore 4-[N-(1-adamantyl)carbamoylacetyl]-13-[N(-n-octadecyl)carbamoylacetyl]-1,7,10,16-tetraoxa-4,13-diazacyclooctadecane, the cesium specific ionophore calix[6]arene-hexaacetic acid hexaethyl ester, the magnesium specific ionophores N,N″-octamethylene-bis(N′-heptyl-N′-methylmethylmalonamide), N,N″-octamethylene-bis(N′-heptyl-N′-methyl-malonamide), N,N′,N″-tris[3-(heptylmethylamino)-3-oxopropionyl]-8,8′-iminodioctylamine, 7-[(1-adamantylcarbamoyl)acetyl]-16-[(octadecylcarbamoyl)acetyl]-1,4,10,13-tetraoxa-7,16-diazacyclooctadecane, the calcium specific ionophores (−)-(R,R)-N,N′-bis[11-(ethoxycarbonyl)undecyl]-N,N′-4,5-tetramethyl-3,6-dioxaoctane-diamide, calcimycin, 10,19-bis[(octadecylcarbamoyl)methoxyacetyl]-1,4,7,13,16-pentaoxa-10,19-diazacycloheneicosane, the barium specific ionophore N,N,N′,N′-tetracyclohexyl-oxybis(o-phenyleneoxy)diacetamide, the heavy metals specific ionophores o-xylylenebis(N,N-diisobutyldithiocarbamate) (particularly copper), S,S′-methylenebis(N,N-diisobutyidithiocarbamate) (particularly silver), O,O″-bis[2-(methylthio)ethyl]-tert-butylcalix[4]arene (particularly silver), methylene bis(2-thiobenzothiazole) (particularly silver), 5-tetradecyl-1,4-dioxa-8,11-dithia cyclotetradecane (particularly silver), 7-tetradecyl-6,9-dioxa-2,13-dithia tetradecane (particularly silver), tetrabutylthiuram disulfide (particularly zinc), N-phenyl-iminodiacetic acid N′-N′-dicyclohexyl-bis-amide (particularly zinc), N,N,N′N′-tetrabutyl-3,6-dioxaoctanedi(thioamide), [1,1′-bicyclohexyl]1,1′-2,2′-tetrol (particularly cadmium), N,N-dioctadecyl-N′,N′-dipropyl-3,6-dioxaoctanediamide (particularly lead), N,N,N′,N′-tetradodecyl-3,6-dioxaoctanedithioamide (particularly lead), tert-butylcalix[4]arene-tetrakis(N,N-dimethylthioacetamide) (particularly lead), tert-butylcalix[6]arene ethyleneoxydiphenylphosphine (particularly lead), N,N,N′,N′-tetradodecyl-3,6-dioxaoctane-1-thio-8-oxadiamide (particularly lead), 5,7,12,14-tetramethyidibenzotetraazaannulene (particularly lead), 1,10-dibenzyl-1,10-diaza-18-crown-6 (particularly lead), O-methyldihexylphosphine oxide O′-hexyl-2-ethylphosphoric acid (particularly uranyl ions), anion specific ionophores such as tridodecylmethylammonium chloride, or the fluoride and chloride specific ionophores chloro (2,3,7,8,12,13,17,18-octaethylporhyrinato) gallium(III), chloro (5,10,15,20-tetraphenylporphyrinato)gallium(III), hydroxo (5,10,15,20-tetrakis(o-pivalamidophenyl)porphyrinato)gallium(III), chloro (2,3,7,8,12,13,17,18-octaethylporhyrinato) indium(III), chloro (5,10,15,20-tetraphenylporphyrinato)indium(III), hydroxo (5,10,15,20-tetrakis(o-pivalamidophenyl)porphyrinato)indium(III), chloro (2,3,7,8,12,13,17,18-octaethylporhyrinato) thallium(III), chloro (5,10,15,20-tetraphenylporphyrinato)thallium(III), [N,N-[4,5-bis(dodecyloxy)-1,2-phenylenebis[nitrilomethylidyne (2-hydroxy-1,3-phenylene)]acetamide]-N,N′O,O′]dioxouranium, 4,5-dimethyl-3,6-dioctyloxy-1,2-phenylene bis(mercury trifluoroacetate), 3,6-didodecyloxy-4,5-dimethyl-1,2-phenylene bis(mercury chloride), [9]mercuracarborand-3, ruthenium(II) (2,3,7,8,12,13,17,18-octaethylporhyrin) carbonyl, trioctyltin chloride, tricyclohexyltin chloride, other ionophores are the triiodide specific ionophore 2,4,6,8-tetraphenyl-2,4,6,8-tetraazabicyclo[3.3.0]octane, nitrite specific ionophores cyano aqua cobyrinic acid heptakis(2-phenylethyl ester), dicyano cobyrinic acid heptapropyl ester, aquo-cyano-cobinamide, the carbonate and sulfide specific ionophors 3,12-bis(trifluoroacetobenzoyl) cholic acid, trifluoroacetyl-p-butylbenzene, octadecyl 4-formylbenzoate, and the sulfate specific ionophores dibecain sulfate, and α,α′-bis(n′-phenylthioureylene)-m-xylene. Particular examples are 4-tert-butylcalix[4]arene-tetraacetic acid tetraethyl ester, 2-dodecyl-2-methyl-1,3-propanediyl bis[N-[5′-nitro(benzo-15-crown-5)-4′-yl]carbamate], 4-[N-(1-adamantyl)carbamoylacetyl]-13-[N-(n-octadecyl)carbamoylacetyl]-1,7,10,16-tetraoxa-4,13-diazacyclooctadecane, (−)-(R,R)-N,N′-bis[11-(ethoxy-carbonyl)undecyl]-N,N′-4,5-tetramethyl-3,6-dioxaoctane-diamide, tridodecylmethylammonium chloride, hydroxo (5,10,15,20-tetrakis(o-pivalamidophenyl)porphyrinato)indium(III), and cyano aqua cobyrinic acid heptakis(2-phenylethyl ester).

Examples of chromoionophores are those selected form the group consisting of 9-(diethylamino)-5-(octadecanoylimino)-5H-benzo[a]phenoxazine, 9-dimethylamino-5-[4-(16-butyl-2,14-dioxo-3,15-dioxaeicosyl)phenylimino]benzo[a]phenoxazine, 9-(diethylamino)-5-[(2-octadecyl)imino]benzo[a]phenoxazine, 5-octadecanoyloxy-2-(4-nitrophenylazo)phenol, 9-(diethylamino)-5-(naphthoylimino)-5H-benzo[a]phenoxazine, 4′,5′-dibromofluorescein octadecyl ester, fluorescein octadecyl ester, 4-(octadecylamino)azobenzene, and N-2,4-dinitro-6-(octadecyloxy)phenyl-2′,4′-dinitro(trifluoromethyl)phenylamine. Particular examples are 9-(diethylamino)-5-(octadecanoylimino)-5H-benzo[a]phenoxazine, and 9-dimethylamino-5-[4-(16-butyl-2,14-dioxo-3,15-dioxaeicosyl)phenylimino]benzo[a]phenoxazine.

Examples of the complex lipophilic inorganic ions are those selected form the group consisting of tetrakis[3,5-bis(trifluoromethyl)phenyl]borate, tetrakis(4-chlorophenyl)borate, tetrakis(4-fluorophenyl)borate, and tetradodecylammonium. Particular examples are tetrakis[3,5-bis(trifluoromethyl)phenyl]borate, and tetradodecylammonium.

In one embodiment of the invention the chemical recognition system comprises one ionophore, one chromoionophore, and one complex lipophilic inorganic ion.

In another embodiment of the invention, the biochemical recognition system comprises an enzyme or enzymes and a color reagent, e.g. an enzyme (e.g. glucose oxidise) which in the presence of oxygen oxidizes an analyte (e.g. glucose) when bound to the enzyme. The recognition system may contain further components that may interact with either the reaction product of this oxidation, gluconic acid or hydrogen peroxide (e.g., the former could protonate a pH indicator or the latter could oxidize a dye) in order to facilitate the optical detection.

In one embodiment of the invention, the optical phenomenon is surface plasmon resonance, and the substrate material is prepared from a plastic base material and a metal surface layer material, the sensor dots being prepared from a polyvinylchloride or crosslinked acrylate comprising a plasticizer. In particular, the metal is gold and the base material is polyetherimide.

In an alternative embodiment of the invention chemical recognition is brought about by the polymer structure itself. Polymeric materials, which responds reversibly to the activity of an analyte and which are characterized by having a polymeric structure comprising cavities are referred to as molecular imprinted polymers. Molecular imprinted polymers are prepared by polymerization of a polymer precursor, e.g. acrylates, in the presence of a template molecule, often the analyte itself. Subsequent, extraction of the template molecule from the polymer matrix affords cavities in the polymer matrix which constitute analyte specific binding sites. Binding of an analyte in the cavity lead to changes in the optical/physical properties of the polymer matrix. In this particular embodiment of the invention the template molecule (here “recognition moiety” although a “negative”) is comprised in the spotting fluid and the chemical recognition site/system is subsequently formed upon washing of the consolidated sensor dots.

As indicated above introduction of a (bio)chemical recognition system into the polymer matrix of a sensor dot can be accomplished in different ways comprising one or more subsequent steps. These steps may comprise one or more washing steps, one or more “pin-ring” depositing steps, as well as one or more consolidation steps, e.g. by exposure to heat, vacuum, or irradiation with different sources.

In one embodiment of the invention the components of the (bio)chemical recognition system are contained in the same spotting fluid as the polymer and/or polymer precursor.

In one embodiment two or more spotting fluids are sequentially deposited at each predetermined position of the planar surface, and wherein the spotting fluids are allowed to consolidate after the last deposition of a spotting fluid.

In another embodiment two or more spotting fluids are sequentially deposited at each predetermined position of the planar surface, and wherein the spotting fluids are allowed to consolidate after deposition of each of the spotting fluids.

In another embodiment of the invention the chemical or biological recognition system may be introduced into (or onto) the polymer matrix of a sensor dot by superimposition of one or more fluids comprising one or more components of the (bio)chemical recognition system, by means of the “pin-ring” depositing technique, onto the pre-formed sensor dot. In this embodiment the fluids comprising the (bio)chemical recognition elements may further comprise a solvent and/or a plasticizer.

This approach may not only be advantageous for the introduction of recognition elements that may be damaged when exposed to polymerization conditions. It may also show to be an economical way of producing (bio)chemical sensor devices with different patterns.

In one embodiment of the invention the chemical recognition system is introduced into the polymer matrix of a sensor dot in the following way: A first spotting fluid comprising a polymer and/or polymer precursor and a plasticizer is deposited onto a substrate material. The spotting fluid is allowed to consolidate. The plasticizer is re-extracted by washing of the consolidated sensor dot with a suitable solvent. A second spotting fluid comprising the (bio)chemical recognition system in the form of components representing one or more (bio)chemical recognition moieties and a plasticizer is deposited on top of the consolidated polymer matrix by re-plasticizing of the polymer matrix. The combination is then allowed to consolidate.

In one embodiment of the invention the (bio)chemical sensor dots may be composed on the support surface by successive superimposition of one or more fluids comprising one or more components selected from the group consisting of solvent, plasticizer, polymerization initiator, and (bio)chemical recognition components, onto droplets of consolidated as well as non-consolidated sensor dots. Each of the successive superimposition steps may be followed by consolidation such as exposure of the sensor dots to heat, vacuum, or irradiation by different sources, by or washing.

In an even more preferred embodiment one or more of the sensor dots represent a reference sensor dot containing a reference polymer matrix which is responsive to the unspecific changes due to effects from temperature, aging, analyte, bulk solution refractive index, swelling of the polymer matrix, ionic strength, or to fluctuations in the light source employed by the sensor transducer. The reference sensor dot may comprise all the components of the sensor dots to which it is a reference except from one or more of the (bio)chemical recognition elements.

The diameter of the (bio)chemical sensor dots is typically 1-1000 μm, more preferably 150-250 μm, and the height of the dots is 0.1-1000 μm, preferably 1-5 μm. The number of fluid superimposition steps normally controls the diameter and the height of a sensor dot.

A (bio)chemical sensor device prepared according to the method of the present invention may be used for parallel detection and quantification of two or more analytes comprised in the same sample. The skilled person in the art will recognize the broad scope of potential application of the invention.

### EXAMPLES

### Example 1

### Modifications of a Commercially Available “Pin-Ring”-Arrayer

A commercially available “Pin-Ring”-arrayer (Affymetrix 417, formerly from Genetic Microsystem as GMS 417) is adapted for the deposition of spotting fluids comprising polymer or polymer precursors rather than biological or biochemical fluids, i.e. adapted for continuous use with organic solvents like ethanol for washing of the pins. Tubings—commonly silicone—are exchanged for more solvent-resistant FEP (fluorethylenpropylene) tubing. In a similar manner, the pumps (AS Thomas) that transport the washing liquid into the wash stations are removed and replaced by the same model in the “chemically resistant” version. The protective lock of the door is deactivated to allow access to the pins for manual washing with tetrahydrofuran using a wash bottle. Flow restrictors rather than clamps (or in addition to clamps) are mounted onto the washing solvent tubing to allow increased control of the solvent spurting out of the nozzle in the wash station. Protective foil can be used to cover the inside of the transparent front door of the instrument to prevent it from damage in case of minor wash solvent splashing. The outlet of the vacuum pump which removes the washing fluid from the bath by aspiration is connected to a laboratory air ventilation system (hood) to prevent significant introduction of solvent vapor into the work environment. The samples are introduced in the arrayer in the wells of a microtiter plate. Common polystyrene plates are not resistant to many organic solvents, which is why polypropylene plates are chosen.

### Example 2

### Preparation of a Plurality of Miniaturized PVC Dots on Glass Materials

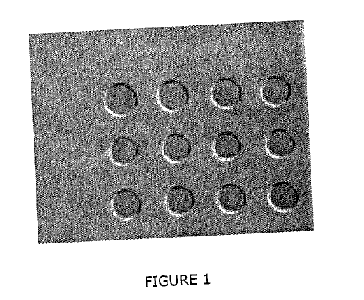

33 mg of poly(vinyl chloride) (PVC) (high molecular weight) and 66 mg plasticizer bis(2-ethylhexyl) sebacate (DOS) are dissolved in 800 μL cyclohexanone. 35 μL of the resulting spotting fluid are filled in well A1 of a 256-well polypropylene microtiter-plate. Using the GMS 417 arrayer with 125 μm-pins, demonstration arrays of PVC dots can easily be deposited on substrates such as commercially available glass or gold-coated glass microscope slides (FIG. 1). Other support surfaces may be placed in the instrument by employing custom-made metal adapter plates. The pin is washed with tetrahydrofuran in order to remove PVC-DOS residues. This may be done manually, or suitable solvents may be used in the washing lines and bath in a correspondingly adapted instrument.

### Example 3

### Preparation of a Plurality of Miniaturized Sodium-Selective (Bio)Chemical Sensor Dots

2.9 mg of 9-(diethylamino)-5-octadecanoylimino)-5H-benzo[a]phenoxazine, 4.6 mg sodium tetrakis[3,5-bis(trifluoromethyl)phenyl]borate, 10.0 mg 4-tert.-butylcalix[4]arene-tetraacetic acid tetraethyl ester, 139.2 mg bis(2-ethylhexyl) sebacate, and 69.1 mg poly(vinyl chloride) (high molecular weight) are dissolved in 2.0 ml cyclohexanone. 35 μL of the resulting spotting fluid is filled in well A1 of a 256-well polypropylene microtiter-plate. Using the GMS 417 arrayer with 125 μm-pins, plasticized PVC based sodium-selective (bio)chemical sensor dots was prepared on gold-coated microscope glass slides. Functionality of the sensing dots. i.e. response to target ion sodium in buffered solution, can be verified by means of fiber optical absorbance spectroscopy or surface plasmon resonance spectroscopy, respectively. The latter detects the refractive index changes in the membrane, that are related to spectral /absorbance changes by the Kramers-Kronig relation.

### Example 4

### Preparation of a Plurality of Sensor Dots Using a Spotting Fluid Comprising Methacrylate

35 μL of spotting fluid made from 160 mg 1,6-hexanediol dimethacrylate, 100 mg dodecyl methacrylate, 200 mg bis(2-ethylhexyl) sebacate and a radical initiator, e.g., 1 mg of α,α-dimethoxy-α-phenylacetophenon, or 2.5 mg of benzoyl peroxide with 5 mg of benzophenone as photosensitizer, is filled in well A1 of a 256-well polypropylene microtiter-plate. Using the GMS 417 arrayer with 125 μm-pins, demonstration arrays of photopolymerized methacrylate sensor dots was made on commercially available microscope slides. After deposition of the spotting fluid, the pin was washed with a suitable solvent such as ethanol. After deposition, the spotting fluid droplets were photopolymerized by exposure to UV-light in an inert-gas atmosphere, typically for 10-20 minutes. Such an experiment demonstrates convincingly that methacrylate cocktail dots can be produced in high number with high accuracy and photopolymerized immedialety afterwards. It is obvious to the person skilled in the art that addition of (bio)chemical recognition components (e.g., an ionophore, a chromoionophore, complex lipophilic inorganic ions) to the spotting fluid in concentrations of few % (w/w) will result in arrays of sensing dots without affecting the deposition process. However, since many of these components are photobleachable, replasticizing can be chosen as an alternate route to introduce the sensing components. Towards this end, plasticized dots without any recognition elements are deposited and subsequently treated with tetrahydrofuran to extract the plasticizer from the material. Afterwards, droplets of a fluid comprising (bio)chemical recognition components (e.g., an ionophore, a chromoionophore, complex lipophilic inorganic ions) in bis(2-ethylhexyl) sebacate may be deposited directly on top of the polymer dots. Given sufficient time, the plasticizer and with it the sensing components are taken up by the polymer matrix, resulting in arrays of functional ion-selective (bio)chemical sensor dots.

### Example 5

### Superimposition of Polymer Dots

5.I

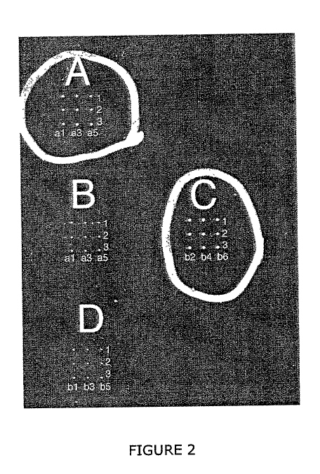

A spotting fluid analogous to that in example 4 was deposited on a glass microscope slide in such a manner that four arrays of three times three dots A, B, C, D were obtained. The dots were then photopolymerized by UV irradiation in an inert gas atmosphere. Subsequently, two arrays were superimposed on top of arrays A and C and polymerized. An image of the sensor dots was taken with the Affymetrix 418 fluorescence scanner (FIG. 2) and confirms the successful superimposition (note the superimposition that failed due to an error of the experimentation in array B, where the two individual arrays are shifted).

5.II

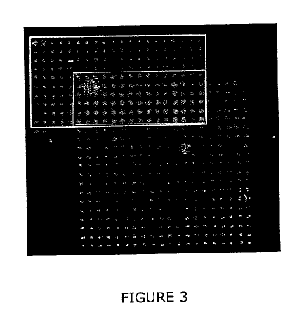

Furthermore, a spotting fluid analogous to that in example 2 was deposited in a 20 by 20 array, using a feature in the calibration software of the arrayer intended for an alignment test. The depositing was repeated with shifted dot location. The scanner image in FIG. 3 shows the two arrays and the area in which they overlap. The slight difference in array appearance is most probably caused by use of a different surface of the microscope slides.

1. A method for the preparation of an optical (bio)chemical sensor device, said device comprising a substrate material having a planar surface portion, said planar surface representing a transducer based on an optical phenomenon; said planar surface portion having arranged thereon a plurality of (bio)chemical sensor dots located at spatially separated predetermined positions of the planar surface, said sensor dots including
(i) a polymer matrix, and
(ii) one or more (bio)chemical recognition moieties,
the method comprising
(a) providing a substrate material having a planar surface portion;
(b) providing one or more spotting fluid(s) each comprising at least one of
(i) a polymer and/or polymer precursor; and
(ii) a component representing one or more (bio)chemical recognition moieties;
(c) depositing either simultaneously or sequentially the one or more spotting fluid(s) at the spatially separated predetermined positions of the planar surface portion of the substrate material by means of a “pin-ring” deposition mechanism and allowing the spotting fluid(s) to consolidate.

2. A method according to claim 1, wherein the optical phenomenon is selected from transmission, fluorescence, and surface plasmon resonance.

3. A method according to claim 2, wherein the optical phenomenon is surface plasmon resonance.

4. A method according to claim 1, wherein the substrate material comprises a base material selected from glasses, silica, dielectric inorganic materials, plastics, and silicon with a hydrogen- or deuterium-terminated surface.

5. A method according to claim 1, wherein the substrate material comprises a planer surface portion consisting of at least one surface layer material selected from metals and silicon.

6. A method according to claim 5, wherein the surface layer material has a thickness of 10-500 nm.

7. A method according to the claim 1, wherein the planar surface of the substrate material is chemically modified by treatment with a bifunctional reagent:
X—Z—Y
wherein
X is selected from —OR′, asymmetric or symmetric disulfides (—SSR′Y′, —SSRY), sulfides (—SR′Y′, —SRY), diselenide (—SeSeR′Y′, —SeSeRY), selenide (—SeR′Y′, —SeR′Y′), thiol (—SH), selenol (—SeH), —N≡C, —NO₂, trivalent phosphorous groups, —NCS, —OC(S)SH, thiocarbamate, phosphine, thio acid (—COSH), dithio acid (—CSSH), —Si(OR/R/H)₃ and halogen,
each of the substituents R and R′ independently are selected from optionally substituted C₁₋₃₀-alkyl, optionally substituted C₂₋₃₀-alkenyl, optionally substituted C₂₋₃₀-alkynyl; and optionally substituted aryl,
Y and Y′ are selected from hydroxyl, carboxyl, amino, formyl, hydrazine, carbonyl, epoxy, vinyl, allyl, acryl, epoxy, and methacryl, and
Z is a linker (biradical) between the two functional groups.

8. A method according to claim 1, wherein at least one of the one or more spotting fluid(s) comprises a polymer selected from polyacrylates, polyanilines, poly(butadiene), polyethylene, poly(ethylene-co-vinyl acetate), polymethacrylates, polystyrenes, polypyrroles, polythiophenes, polyurethanes, poly(vinyl acetate), poly(vinyl alcohol), poly(vinyl chloride), epoxy novolac resins, and co- or terpolymers of the before-mentioned polymers.

9. A method according to claim 1, wherein at least one of the one or more spotting fluid(s) comprises a polymer precursors selected from monomeric acrylates, monomeric methacrylates, oligomers and crosslinkers.

10. A method according to claim 1, wherein at least one of the one or more spotting fluid(s) comprises a plasticizer.

11. A method according to claim 8, wherein at least one of the one or more spotting fluid(s) comprises a plasticizer.

12. A method according to claim 9, wherein at least one of the one or more spotting fluid(s) comprises a plasticizer.

13. A method according to claim 8, wherein the spotting fluid comprises a polymerization initiator.

14. A method according to claim 9, wherein the spotting fluid comprises a polymerization initiator.

15. A method according to claim 1, wherein the (bio)chemical recognition moieties are selected from ionophores, chromoionophores, and complex lipophilic inorganic ions.

16. A method according to claim 1, wherein the spotting fluid(s) are allowed to consolidate upon exposure to heat, irradiation with ultraviolet light, irradiation with visible light, or by means of electron induced excitation.

17. A method according to claim 1, wherein two or more spotting fluids are sequentially deposited at each predetermined position of the planar surface, and wherein the spotting fluids are allowed to consolidate after the last deposition of a spotting fluid.

18. A method according to claim 1, wherein two or more spotting fluids are sequentially deposited at each predetermined position of the planar surface, and wherein the spotting fluids are allowed to consolidate after deposition of each of the spotting fluids.

19. A method according to claim 1, wherein each of the (bio)chemical sensor dots comprises different (bio)chemical recognition moieties.

20. A method according to claim 19, wherein the sensor device comprises at least 5 different sensor dots.

21. A method according to claim 1, wherein optical phenomenon is surface plasmon resonance, and the substrate material is prepared from a plastic base material and a metal surface layer material, the sensor dots being prepared from a polyvinylchloride or crosslinked acrylate comprising a plasticizer.

22. A method according to claim 21, wherein the metal is gold and the base material is polyetherimide.

23. A (bio)chemical sensor device obtainable by the method of claim 1.

24. A (bio)chemical sensor device according to claim 23, wherein each of the (bio)chemical sensor dots comprises different (bio)chemical recognition moieties.

25. A method according to claim 24, wherein the sensor device comprises at least 5 different sensor dots.

26. A method for monitoring and/or characterizing two or more analytes, wherein an optical (bio)chemical sensor device according to claims 21 is used.

27. A method according to claim 26, wherein a surface plasmon resonance technique is utilized in combination with the optical (bio)chemical sensor device.
